(19) United States
(12) Patent Application Publication
(10) Pub. No.: US 2004/0235675 A1
(43) Pub. Date: Nov. 25, 2004

(54) OILFIELD TREATMENT FLUID STABILIZER

(75) Inventor: Xiaoping Qiu, Sugar Land, TX (US)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(73) Assignee: SCHLUMBERGER TECHNOLOGY CORP., Sugar Land, TX (US)

(21) Appl. No.: 10/249,948

(22) Filed: May 21, 2003

(51) Int. Cl. C09K 7/02

(52) U.S. Cl. 507/200

(57) ABSTRACT

Non-toxic high temperature stabilizers are described for compositions for treating subterranean formations using fluids that are hydrated from dry mix blends using controlled release methods of particle dissolution. In particular, one aspect of this invention is a dry blended particulate composition for hydraulic fracturing containing a particulate hydratable polysaccharide, a particulate crosslinking agent, a slowly releasing particulate base, and a non-toxic stabilizing salt for high temperature use. The dry blended particulate composition is capable of significantly improving rheological properties. It is useful for making hydraulic fracturing and other oilfield treatment fluids.

### BACKGROUND OF INVENTION

The invention relates primarily to dry blend compositions for generating viscous oilfield treatment fluids. More particularly it relates to high-temperature stabilizers for such fluids.

In the recovery of hydrocarbons from subterranean formations it is common practice, particularly in formations of low permeability, to fracture the hydrocarbon-bearing formation, providing improved flow channels. These flow channels allow the oil or gas to reach the wellbore so that it may be pumped from the well. In such fracturing operations, a fracturing fluid is hydraulically injected down a wellbore penetrating the subterranean formation and is forced against the formation by pressure. The formation is forced to crack and fracture, and a proppant is placed in the fracture by movement of a viscous fluid containing proppant into the crack in the rock. The resulting fracture, with proppant in place, provides improved flow of the recoverable fluid, i.e., oil, gas, or water, into the wellbore.

Water-based hydraulic fracturing fluids typically consist primarily of a thickened or gelled aqueous solution formed by metering and combining large volumes of fluids at the surface, mixing them together in large mixing apparatus, and blending them with proppant before pumping the fracturing fluid mixture downhole. Proppant particles carried by the fracturing fluid remain in the fracture created, thus propping open the fracture, when the fracturing pressure is released and the well is put in production. Suitable proppant materials include sand, sintered bauxite, or similar materials. The “propped” fracture provides a larger, higher permeability, flow channel to the well bore through which an increased quantity of hydrocarbons can flow, thereby increasing the production rate of the well.

Obstacles facing the fracturing industry include high costs, complexity of operations, and the environmental effects of operating and conducting fracturing treatments. High costs are associated with storing and maintaining numerous liquids in large quantities in various, and sometimes remote, regions of the world. Accurately metering and mixing a large number of components, some of which may be liquids and some of which may be solids, often makes these operations very complex. Further, the environmental effects of spillage and relatively large leftover quantities of fluid on site are increasingly becoming a problem for fracturing operators, as disposal of fluids is particularly troublesome under newer and more stringent environmental regulations.

Water-based hydraulic fracturing fluids may contain a hydratable polymer that acts to thicken the fracturing fluid and may be further thickened by chemically crosslinking. Such a polymer typically is obtained in a powdered form, or slurried in a hydrocarbon such as diesel, and is hydrated at the surface, commonly in a batch mix liquid operation in large mixing tanks for a significant period of time, or in a continuous mix operation in smaller tanks, and then mixed with other liquid additives of various types using large expensive equipment. After hydration, the polymer is crosslinked to further thicken the fluid and improve its viscosity at the elevated temperatures often encountered in the fracture, so that it can carry proppant into the fracture once it is pumped into a wellbore below the surface. Natural polymers often used include polysaccharides, such as guar and derivatives of guar such as hydroxypropyl guar, carboxymethylhydroxypropyl guar, carboxymethyl guar, or hydrophobically modified guar. Borate, zirconium and titanium-containing crosslinking agents typically are used. Both borate and organometallic crosslinking agents offer advantages depending upon the fluid performance and cost requirements of the particular fracturing treatment.

Numerous chemical additives such as antifoaming agents, acids or bases, or other chemicals may be added to provide appropriate properties to the fluid.

It has long been recognized that large cost savings and convenience could be achieved by using a dry blend composition (i.e. similar in concept to a “cake mix”) which is conveniently prepackaged for worldwide shipment, and which contains essentially all of the chemicals needed to prepare a fracturing fluid in one dry granular packaged unit. Unfortunately, however, the granular compositions of the prior art have not provided the required storage stability and fluid properties needed in the industry, and have not offered the advantages that may be realized by embodiments of this invention.

For example, U.S. Pat. No. 4,505,826 to Horton discloses a mixture of dry ingredients which, under some conditions, is stated to be capable of crosslinking at temperatures in the range of about 27 Â° C. to about 54 Â° C. Zirconium acetyl acetonate is used as the crosslinking agent. The process, as set forth in the patent, apparently requires that the crosslinking agent become active before the gelling composition is completely hydrated. It is stated that if crosslinking of that particular fluid system is begun before the gelling composition is completely hydrated, further hydration is essentially halted and peak viscosity will never be reached, resulting in an inferior fluid.

Until recently, it had been widely believed that hydration and crosslinking of a fracturing fluid composition could not occur simultaneously, because it was believed that no fracturing fluid system could achieve sufficient viscosity if it was “prematurely” crosslinked before the guar was fully and completely hydrated. The compositions, methods, and apparatus disclosed in U.S. Pat. No. 5,981,446, assigned to the assignee of the present application, and hereby incorporated by reference in its entirety, solved this problem and provided an effective dry particulate composition (“dry blend”) that would generate a stable viscous fluid at times and temperatures such that it could be added to an aqueous fluid on the surface and become a stable viscous fluid when it was pumped into a hot formation. However, for optimal stability above about 93 Â° C., the compositions disclosed in that patent required sodium fluoride (NaF) to be included in the dry particulate mixture. Dry NaF causes severe irritation or burns to the skin or eyes on contact and may be severely damaging to the respiratory passage or lungs if inhaled. Consequently, there is a need for a high-temperature dry blend that forms gels stable above 93 AOC but does not contain NaF.

### SUMMARY OF INVENTION

One embodiment is a dry blended particulate composition for oilfield treatment containing a particulate hydratable polysaccharide, a particulate borate crosslinking agent effective to crosslink the hydratable polysaccharide composition substantially without prolonged mixing operations above ground, a particulate slowly releasing base, and a particulate salt, the anion of which is capable of reacting with the cation of the particulate base when both are dissolved in an aqueous fluid, in an amount effective to increase the pH of the aqueous fluid and to stabilize the crosslinking of the hydratable polysaccharide. The overall dry blend is generally capable of simultaneous hydration and crosslinking.

In embodiments of the invention, the hydratable polysaccharide is selected from guar and guar derivatives including hydroxypropyl guar, carboxymethyl guar, carboxymethylhydroxypropyl guar, hydrophobically modified guar, synthetic polymers, and guar-containing compounds. A dry buffer system optionally may be included to adjust the pH rapidly to allow hydration to begin. Also included is a particulate crosslinking agent, selected from borates, zirconates, and titanates. The crosslinker is preferably encapsulated borate, most preferably encapsulated with an acrylic polymer emulsion. Also included is a particulate metal oxide, preferably magnesium oxide, which adjusts the pH and allows crosslinking to begin, and an effective amount of a stabilizing particulate salt. The anion of the stabilizing particulate salt is capable of reacting with the cation of the particulate base, when both are dissolved in an aqueous fluid, to increase the pH of the aqueous fluid and stabilize the crosslinking of the hydratable polysaccharide to stabilize the composition. The stabilizing particulate salt is preferably selected from the group of compounds including sodium, potassium, and ammonium pyrophosphates, hydrates of those salts, and mixtures of those salts, and sodium, potassium, and ammonium oxalates, hydrates of those salts, and mixtures of those salts. The preferred particulate salt is tetrasodium pyrophosphate.

High temperature stabilizers to prevent oxidative degradation of the polymer optionally may be employed, including sodium thiosulfate. Stable, dry viscosity breakers could also be present, such as enzymes, encapsulated oxidizers, or oxidizers which are activated only at high temperatures. In other embodiments the dry blend may include clay-stabilizing salts, antifoam agents, foaming agents, bactericides and other components commonly used in well treatment fluids. Fluids formed from the dry blends may be foamed or energized.

Another embodiment is a method of fracturing, frac-packing, or gravel packing that includes the steps of mixing water with the dry blended particulate composition and injecting the resulting fluid into a wellbore.

### BRIEF DESCRIPTION OF DRAWINGS

FIG. 1 shows the pH vs. time when dry blends containing sodium oxalate are added to water.

FIG. 2 shows the pH vs. time when dry blends containing sodium stearate are added to water.

FIG. 3 shows the pH vs. time when dry blends containing sodium pyrophosphate are added to water.

FIG. 4 shows the viscosity vs. time when dry blends containing sodium pyrophosphate are added to water.

### DETAILED DESCRIPTION

One key aspect of the dry blend concept for creating crosslinked polymer gels is that the release of the particulate borate crosslinking agent and the release of the particulate base are controlled by the rates of particle dissolution. Another key aspect is that the quality of the crosslinked polymer gel can be satisfactory even if the polymer is not fully hydrated before the crosslinking begins. A third key aspect is that the stability of the crosslinked gel depends upon the pH. As the temperature of use increases, the pH necessary to maintain a stable gel structure increases. This application addresses primarily that third aspect.

Embodiments of the invention will be discussed primarily in terms of continuous mix fracturing, although batch mixing may be used to make the crosslinked gelled fluid, and that fluid may be used in other oilfield treatments. One of the major difficulties in designing chemistry and equipment for continuous mix fracturing is the short time frame in which events must occur. For example, in typical South Texas fracturing treatments, it is not unusual for treatment rates to be as high as about 11 kL/minute. This quantity of fluid flow is very large, and at this high rate, a typical guar-metering rate would be about 55 kg/minute and a typical proppant rate could be over 5,000 kg/minute. Hydration time becomes significant in designing equipment and providing the appropriate amount of mixing energy. The equipment must be portable, and must conform to weight and dimensional regulations for road transport. Fast hydration is greatly preferred.

In a desirable sequence of events there is very rapid hydration, crosslinking and downhole pumping of the fracturing fluid. Since field water often has a higher pH, during the first 20 seconds, in a suitable embodiment an optional buffer stabilizes and lowers the pH of the dry mix/water combination to a pH, preferably between about 5 and about 7, at which the polymer hydrolyzes rapidly. Once pH is lowered, then a slowly releasing base begins to raise the pH as required to achieve crosslinking; this step in a suitable embodiment occurs between about 40 seconds and 120 seconds. Lastly, the fluid begins the crosslinking process well before hydration is complete, at about 110 seconds in a suitable embodiment, and the fracturing fluid is rapidly blended with proppant and pumped downhole. All of these times can be different. The basic sequence of events is that pH is initially lowered to facilitate uncurling and stretching of the polysaccharide chains, followed by hydration and then, soon thereafter, by crosslinking of the polysaccharide chains. This is made possible, in part, by the slight delay in availability of base to raise the pH followed by a slightly longer delay in availability of the crosslinking species. Timing is important in the deployment of dry blends. The systems are typically designed so that most of the hydration and crosslinking will take place in the tubing, utilizing the mixing energy developed from pumping.

Apparatus and procedures for using the dry blend composition were described in U.S. Pat. No. 5,981,446, assigned to the assignee of the present application, and hereby incorporated by reference in its entirety. The compositions, apparatus and methods were described in that patent for conventional hydraulic fracturing, but they may be used for slickwater fracturing, frac-packing, or gravel packing as well. The compositions may also be used for any treatments in which a high pH viscous fluid is needed. Other apparatus and procedures may be used, as would be apparent to one skilled in the art, within the scope of the invention. As an example, for fracturing, an operator may simply start with a dry blended particulate, mix it with an aqueous fluid to form a fracturing fluid, add a proppant, and inject the resulting slurry. As another example, an operator may start with a dry blended particulate, mix it with a first aqueous fluid to form a dispersed fracturing fluid concentrate, and then mix the dispersed fracturing fluid concentrate with a second aqueous fluid to form a fracturing fluid, add a proppant, and then pump the slurry into a wellbore. As another example, an operator may form a slurry of the dry blend in a suitable hydrocarbon, such as diesel, a mineral oil, or a non-toxic natural or synthetic oil. This slurry may be made well in advance of the treating operation, and even in a different location, or it may be made on site immediately before use. This non-aqueous slurry is then added to an aqueous fluid to form a fracturing fluid, a proppant is added, and then the slurry is pumped into a wellbore.

A suitable polymer is a particulate hydratable polysaccharide formed of discrete particles and capable of continuous mixing to form a viscous fracturing fluid composition. Suitable hydratable polysaccharides are selected from guar and guar derivatives including hydroxypropyl guar, carboxymethyl guar, carboxymethylhydroxypropyl guar, hydrophobically modified guar, synthetic polymers, and guar-containing compounds Hydratable polymers typically hydrate rapidly and readily only at certain pH's. Anyone skilled in the art will know the proper pH for a given polymer and appropriate buffers to achieve that pH. A dry buffer system optionally may be included to rapidly adjust the pH to allow hydration to begin.

A suitable crosslinking agent is a particulate crosslinking agent that is effective at crosslinking the hydratable polysaccharide composition substantially without prolonged mixing operations above ground. The crosslinking agent is preferably selected from borates, zirconates, and titanates. Optionally, the particulate crosslinking agent is encapsulated with a coating that is dissolvable at pH values greater than about 8. One of the most suitable coating techniques known in the art for pumping service application is the Wurster Process, in which particles are spray-coated while suspended in an upward-moving air stream. This process is one preferred method to achieve encapsulation or coating for deployment of embodiments of this invention. Top spray fluidized bed techniques also may be used to prepare the encapsulated particles. These methods may be used for encapsulation of the crosslinker and the particulate base. The encapsulant is selected from the group of encapsulants comprising acrylic resins, acrylic polyols, acrylic polymers, styrenated acrylic polymers, styrene acrylic polymers having colloidal solutions or emulsions, polyvinylidene chloride, hydroxypropylmethylcelluloses, ethylcelluloses, ethylene acrylic acid polymers, carboset-acrylic resins, and polytetrafluoroethylenes.

Adding boric acid without encapsulation also can affect the release time. A dry blend, therefore, also can include unencapsulated borate to adjust the desired crosslink time of fluids (or the rate of the viscosity development process). If a long delay in crosslink is desired, high coating level can be applied. If shorter delay or early viscosity is desired, a thinner coating (or a heavier coating combined with unencapsulated borate) can be used. When unencapsulated borate is added to the dry blend, the crosslinking time of the fluid is shortened; however, when too much unencapsulated borate is added to the dry blend, the hydration of polymer is inhibited and this results in poor viscosity. Thus proper formulation is a matter of balance.

Suitable particulate slowly releasing bases are metal oxides, especially particulate magnesium oxides, calcium oxides, strontium oxides, and oxides of group Ila metals, and most especially particulate magnesium oxides. The rate of dissolution of the base may be controlled by a variety of well-known methods such as selection of the base itself, selection of the particle size (or particle size distribution) of the base, scintering of the base, or coating of the base with an agent that will delay the dissolution, for example encapsulating the base with a material that does not dissolve readily until the pH has increased to at least about 8. The slowly releasing base may also be a mixture of bases; a common mixture is a mixture of two different magnesium oxides that dissolve at different rates.

Magnesium oxide (MgO) can control the pH, convert boric acid to borate, and stabilize a viscous crosslinked gel formed in an aqueous fluid by a dry blend up to a temperature of about 93 Â° C. However, above about that temperature, it has been found that MgO alone cannot effectively perform that role. At higher temperatures, another additive is required, which will be called here a high temperature stabilizer. It increases the pH further. In U.S. Pat. No. 5,981,446 NaF was proposed as the high temperature stabilizer. Not to be limited by theory, but it is believed that the NaF works according to the following equation:

The molecular weight of MgO is 40.3 g/mole and the molecular weight of NaF is 42 g/mole; therefore, approximately twice the weight of NaF as MgO would precipitate the Mg as MgF₂ and release approximately two moles of base for each mole of MgO. Unfortunately, NaF is toxic, so an alternative would be desirable. A suitable alternative would be a particulate salt that dissolves in water as the rest of the dry blend system dissolves to release an anion that reacts with the Mg⁺⁺ to precipitate an insoluble magnesium compound. It is important that precipitation of Mg(OH)₂ be prevented. It is also important that the precipitate interfere as little as possible with the flow of fluids where it is used, for example in a proppant pack or in a formation. It is believed therefore that the precipitate should not be much more voluminous than the amount of MgF₂ that would be produced. It is also important that the particulate salt, its ions, and the magnesium-containing precipitate compound formed, all be compatible with all the other components of the dry blend and of the fluid. Precipitation of magnesium and generation of hydroxide is not sufficient; some particulate salts that achieve these ends do not provide viscous fluids stable at high temperature. They interfere with the proper action of the other components of the dry blend or with the behavior of the fluid.

Suitable particulate stabilizing salts have been found to be compounds such as sodium, potassium, and ammonium pyrophosphates, hydrates of those salts, and mixtures of those salts; and sodium, potassium, and ammonium oxalates, hydrates of those salts, and mixtures of those salts. The major factors affecting the amount of the particulate stabilizing salt used are the amounts of the other components present in the dry blend, the final temperature at which the fluid will be used, the temperature profile of the fluid as it is heated to the final temperature, and the time by which it is required that adequate viscosity be developed (the “crosslink time” or “crosslink delay time”). In fact, the crosslink delay time can be adjusted by varying the amount of particulate salt stabilizer. Typical concentrations for typical dry blend compositions are shown in the examples. Simple experiments, such as those described in the examples, may be used to optimize the particulate salt stabilizer concentration within the scope of embodiments of the invention. Operators would normally already perform similar experiments to optimize the concentrations of polymer, crosslinker and other components.

Fluids formed form the dry blend composition embodiments may be foamed or energized, preferably with nitrogen or carbon dioxide. Techniques, apparatus, and suitable foaming agents are well known.

Although the methods have been described here for, and are most typically used for, hydrocarbon production, they may also be used in storage wells and injection wells, and for production of other fluids, such as water or brine.

Experiment I.

A representative composition for 100 grams of a high temperature dry ble

TABLE 1

Chemical Name
Bactericide
KCl
Solid antifoam (polypropylene glycol)
Guar
Magnesium oxide (MagChem 20)
Sodium thiosulfate
NaF
Boric acid with 7% SCX1530 coating
Sodium acetate (anhydrous)
Citric acid

The encapsulated borate with 7% SCX1530 coating in the examples was coated in an industrial scale coater, applied by the Wurster process. SCX1530 is an acrylic polymer emulsion available from SC Johnson Polymer, 1525 Howe Street, Racine, Wis., 53403 USA. The MgO was obtained from Martin Marietta Magnesia Specialties, Inc., 195 Chesapeake Park Plaza, Suite 200, Baltimore, Md. 21220, USA, as MagChem 20.

Addition of 14.20 g of this dry blend mixture to 1 L water makes a fluid equivalent to about 3.83 g/L of guar, initially containing about 1.80 g/L of NaF. In a typical laboratory experiment, a dry blend was added to a Waring blender with 1 L water and the speed set at 2100 rpm. After mixing for 1 minute, the fluid was pumped into a controlled shear mixer where the fluid was sheared at 1300 rpm for 5 minutes, which simulated the mixing conditions for fluid pumped through 7.30 cm diameter tubing at about 2385 L/minute for 5 minutes. Afterwards, the fluid was pumped directly into a Fann 50 cup and long-term rheology was measured.

In order to compare other potential high temperature stabilizer particulate salts to NaF, dry blends were prepared so that all the components except for the NaF were present in the same relative amounts as in the dry blend shown in Table 1. Varying amounts of various particulate salt candidates were then added to make a dry blend for each experiment. Amounts of these dry blends were then added to water so that the final amount of guar present in each experiment in Examples 1 and 11 was equivalent to about 3.83 g/L of guar, but the amount of the particulate salt candidate varied.

The first candidate tested was sodium oxalate, Na₂C₂O₄ The reaction with MgO would be as follows, producing insoluble magnesium oxalate:

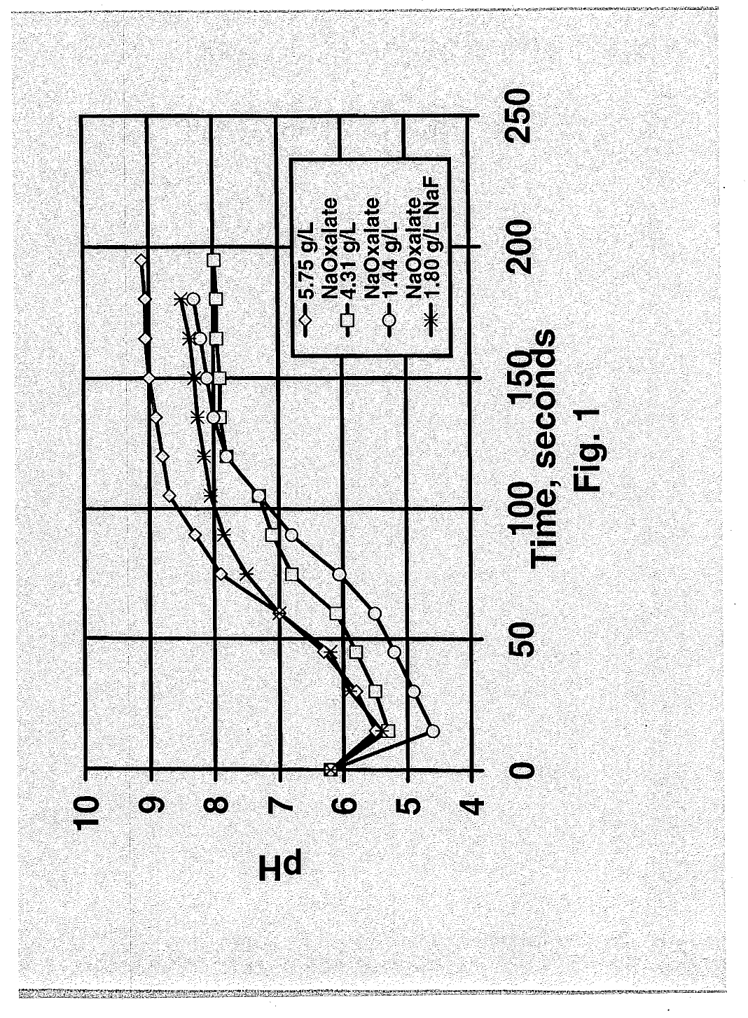

Amounts of a dry blend containing sodium oxalate were added to water so initially about 1.44, 4.31, and 5.75 g/L of sodium oxalate. FIG. 1 shows OLE_LINK1Â°OLE_LINK1C when these three dry blends and the dry blen with sodium oxalate appeared to be fairly close to that with NaF, except a the pH appeared to increase a little more after about 1 minute. This may s with these formulations were then tested in a Fann 50 rheometer at about viscosities in cP at a shear rate of 100 sec⁻¹.

TABLE 2

| | 5.75 g/L | 4.31 g/L |
|---|---|---|
| Time (min) | Na Oxalate | Na Oxalate |
| 3 | 66 | 63 |
| 20 | 38 | 118 |
| 50 | 110 | 111 |
| 80 | 81 | 65 |
| 110 | 81 | 41 |

The data clearly show that sodium oxalate at these concentrations is not a preferred stabilizer for the gel made with this dry blend formulation. However, this experiment does not rule out the use of sodium (or another) oxalate at a different concentration or at lower temperatures, or in a situation in which full viscosity does not need to be developed until the fluid reaches the region of the wellbore to be treated and in which the viscosity requirement is of short duration, such as in gravel packing.

Experiment II.

Sodium stearate, Na(C₁₈H₃₅O₂) was tested as a stabilizer. Sodium stearate is believed to react with MgO as follows, producing one mole of magnesium distearate per mole of MgO:

The molecular weight of MgO is 40.3 g/mole and two moles of sodium stearate, at 307 g/mole each, would be required for a stoichiometric reaction. It was believed that this would require too much additive and would generate too great a volume of precipitate, so sodium stearate was evaluated in less than stoichiometric amounts.

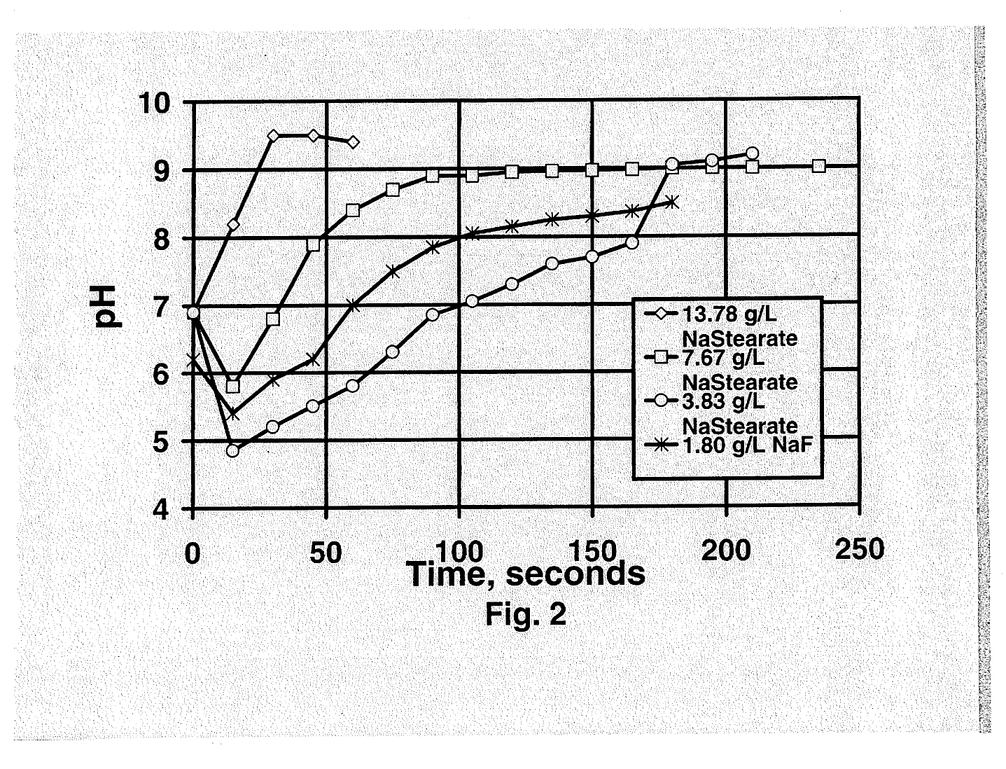

Amounts of a dry blend containing sodium stearate were added to water s initially about 3.83, 7.67, and 13.78 g/L of sodium stearate. FIG. 2 show these three dry blends and the dry blend of Table 1 were added to water lower and stayed lower than with 1.80 g/L NaF. With the higher amounts o the pH observed with the NaF; this would not have allowed the guar enou Despite these results, fluids made with these formulations were then teste shown in Table 3, which shows viscosities in cP at a shear rate of 100 sec

TABLE 3

| | 13.78 g/L | 7.67 g/L |
|---|---|---|
| Time (min) | Na Stearate | Na Stearate |
| 3 | 330 | 147 |
| 20 | 155 | 5 |
| 50 | 29 | 4 |
| 80 | 16 | 5 |
| 110 | 8 | 4 |

These data show that sodium stearate does not have the ability to stabilize the fluid as the temperature increases to the high temperature range, above about 93 AOC. With the two lower sodium stearate concentrations, the viscosity dropped very rapidly when the temperature reached 121 Â° C. At a concentration that is undesirably high, as explained above, the viscosity was acceptable for 20 minutes, but then quickly dropped. Furthermore, the fluids appeared to contain waxy solids at the ends of the tests. Sodium stearate is not acceptable.

Experiment III.

Sodium pyrophosphate, Na P 0 was tested as a stabilizer. Sodium pyrophosphate is believed to react with MgO as follows, producing one mole of insoluble magnesium pyrophosphate per mole of MgO:

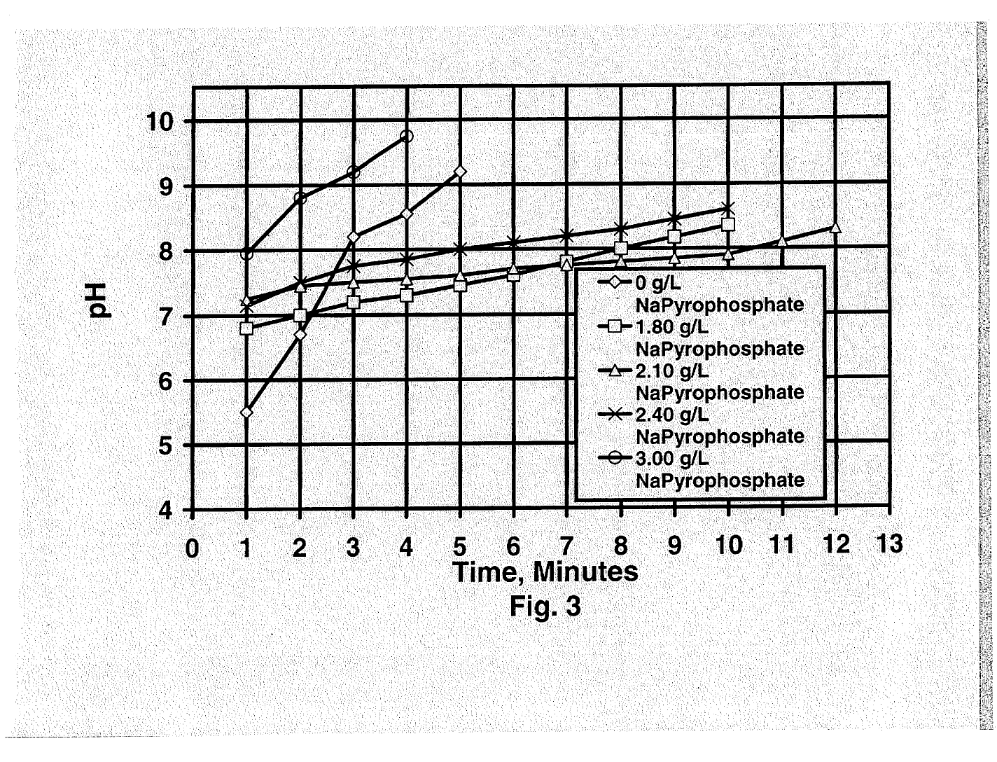

It can be seen that one mole of sodium pyrophosphate (266 g/mole) will react with 2 moles of MgO (40.3 g/mole) to produce 4 moles of base. Amounts of a dry blend containing sodium pyrophosphate were added to water so that the final fluid contained 4.79 g/L of guar, all other components in the same amounts as in examples I and II, and initially 0.00 and about 1.80, 2.10, 2.40, and 3.00 g/L sodium pyrophosphate. FIG. 3 shows the pH of the fluids vs. time at about 24 Â° C. when these five dry blends were added to water. The use of about 1.80 to about 2.10 g/L sodium pyrophosphate with this dry blend increased the early pH to about 6.5 to 7 and had a tendency to retard further pH gains; this resulted in delaying the crosslinking of the fluid at 24 Â° C. Not to be limited by theory, but it is believed that this delay may have been due to surface coating of the MgO by the sodium pyrophosphate or to the complex buffering effect between the sodium pyrophosphate and the buffer already in the dry blend composition. When more sodium pyrophosphate was used (3.00 g/L) the pH of the fluid increased faster than the pH of the fluid made with the dry blend with no added particulate salt stabilizer.

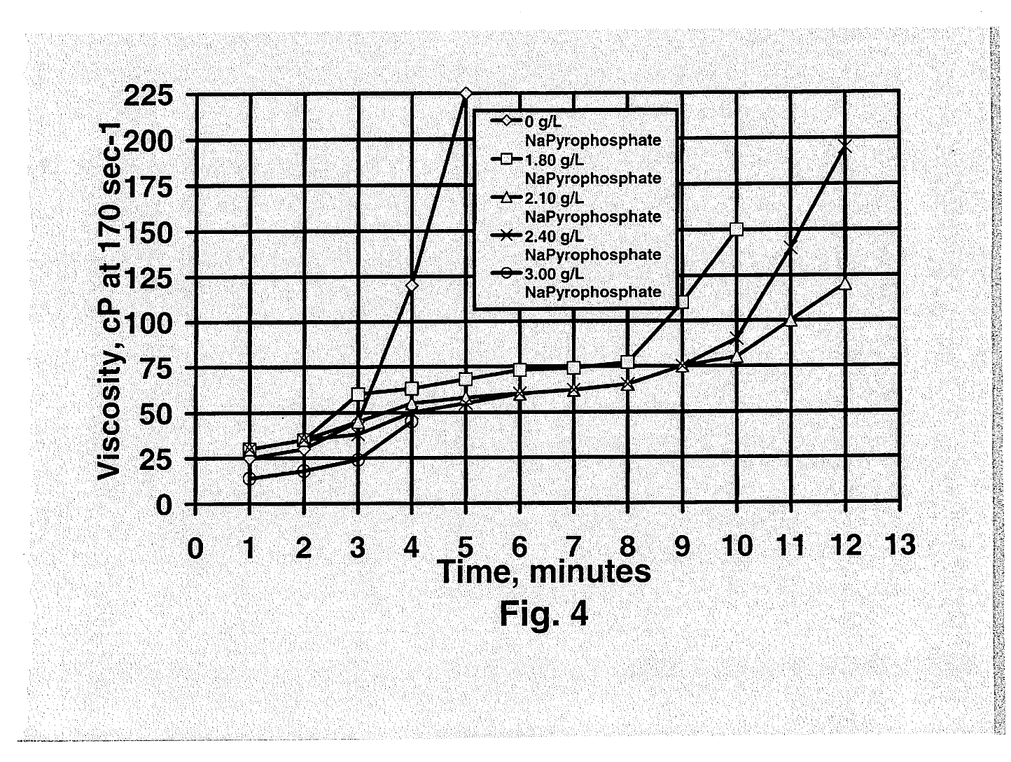

FIG. 4 shows the development of viscosity of the fluids of FIG. 3. The trends are similar to those in FIG. 3 because of the relationship of crosslink delay time to pH development. The data show that the crosslink delay time can be adjusted to vary over a broad range. This makes it possible to use the dry blend with sodium pyrophosphate with a variety of choices of mixing equipment residence times by adjusting the amount of sodium pyrophosphate used.

Table 4 shows the results of rheology testing with heating. Viscosities were rate of 100 sec

TABLE 4

| | | | | |
|---|---|---|---|---|
| Temperature ° C. | 121 | 135 | 149 | 163 |
| Minutes to Temperature | 34 | 40 | 40 | 20 |
| g/L guar | 3.83 | 4.19 | 5.39 | 5.99 |
| g/L sodium pyrophosphate | 1.50 | 1.64 | 2.11 | 2.34 |
| g/L encapsulated boric acid | 0.81 | 0.98 | 1.36 | 1.61 |
| Viscosity, 5 min (cP) | >1000 | >1000 | 400 | 75 |
| Viscosity, 10 min (cP) | 500 | 525 | 400 | 300 |
| Viscosity, 15 min (cP) | 325 | 525 | 400 | 400 |
| Viscosity, 20 min (cP) | 300 | 500 | 400 | 325 |
| Viscosity, 30 min (cP) | 285 | 350 | 400 | 300 |
| Viscosity, 60 min (cP) | 225 | 250 | 400 | 300 |
| Viscosity, 90 min (cP) | 275 | 325 | 400 | 200 |
| Viscosity, 120 min (cP) | 275 | 325 | 400 | 100 |
| Viscosity, 180 min (cP) | 285 | 310 | 400 | |

It is clear that the fluids were very stable.

1. A dry blended particulate composition for well treating, comprising:
a) a particulate hydratable polysaccharide,
b) a particulate crosslinking agent,
c) a particulate base, and
d) a particulate salt selected from the group consisting of sodium, potassium, and ammonium pyrophosphates, hydrates thereof, and mixtures thereof, and sodium, potassium, and ammonium oxalates, hydrates thereof, and mixtures thereof.

2. The dry blended particulate composition of claim 1, wherein the hydratable polysaccharide is selected from the group consisting of guar, hydroxypropyl guar, carboxymethyl guar, carboxymethylhydroxypropyl guar, hydrophobically modified guar, synthetic polymers and mixtures thereof.

3. The dry blended particulate composition of claim 1, wherein the particulate base is a slowly releasing base which provides a delay in the availability of base, when said composition is added to an aqueous fluid, to raise the pH to the level required to achieve crosslinking.

4. The dry blended particulate composition of claim 1, further comprising a particulate buffer capable of rapidly adjusting the pH of the composition into the desired range for polysaccharide hydration.

5. The dry blended particulate composition of claim 1, wherein the particulate crosslinking agent is selected from the group consisting of a particulate borate, a particulate zirconate, and a particulate titanate.

6. The dry blended particulate composition of claim 5, wherein the particulate crosslinking agent is a particulate borate.

7. The dry blended particulate composition of claim 6, wherein the particulate borate is an encapsulated borate encapsulated with a coating, the coating being dissolvable at pH values greater than about 8 when said composition is added to an aqueous fluid.

8. The dry blended particulate composition of claim 7, wherein the coating is selected from the group consisting of acrylic resins, acrylic polyols, acrylic polymers, styrenated acrylic polymers, styrene acrylic polymers having colloidal solutions or emulsions, polyvinylidene chlorides, hydroxypropylmethylcelluloses, ethylcelluloses, ethylene acrylic acid polymers, carboset-acrylic resins, polytetrafluoroethylenes, and mixtures thereof.

9. The dry blended particulate composition of claim 1, further comprising a clay stabilizing particulate salt.

10. The dry blended particulate composition of claim 1, further comprising an antifoaming agent.

11. The dry blended particulate composition of claim 3, wherein the particulate base is a metal oxide.

12. The dry blended particulate composition of claim 11, wherein the metal oxide is selected from magnesium oxides, calcium oxides, strontium oxides, and oxides of group IIa metals.

13. The dry blended particulate composition of claim 12, wherein the metal oxide is one or more magnesium oxides.

14. The dry blended particulate composition of claim 13, wherein the metal oxide is two or more magnesium oxides capable of dissolving in an aqueous fluid at different rates.

15. The dry blended particulate composition of claim 1 mixed with a hydrocarbon to form a slurry.

16. The dry blended particulate composition of claim 1, further comprising an oxygen scavenging high temperature stabilizer.

17. The dry blended particulate composition of claim 1, wherein the particulate salt is selected from the group consisting of tetrasodium pyrophosphate, disodium pyrophospahate, tetrasodium pyrophosphate decahydrate, and tetrapotassium pyrophosphate.

18. The dry blended particulate composition of claim 17, wherein the particulate salt is tetrasodium pyrophosphate.

19. A method of treating a subterranean formation penetrated by a wellbore using a fluid that is rapidly hydrated at the well site using as a starting ingredient the dry blended particulate composition of claim 1 comprising:
a) providing an aqueous fluid,
b) providing the dry blended particulate composition,
c) mixing the aqueous fluid and the dry blended particulate composition to form a treatment fluid, and
d) pumping the treatment fluid into the wellbore.
